(19) United States
(12) Patent Application Publication
(10) Pub. No.: US 2022/0340498 A1
(43) Pub. Date: Oct. 27, 2022

(54) METHOD FOR PRODUCING PLANT NUTRIENTS FROM PLANT AND ANIMAL MATERIAL

(71) Applicants: Erick SCHMIDT, Ponoka (CA); Randall Glen ANDREWS, Edmonton (CA)

(72) Inventors: Erick SCHMIDT, Ponoka (CA); Randall Glen ANDREWS, Edmonton (CA)

(21) Appl. No.: 17/766,024

(22) PCT Filed: Oct. 1, 2020
(86) PCT No.: PCT/IB20/59211

§ 371 Date: Apr. 1, 2022

Related U.S. Application Data
(60) Provisional application No. 62/910,947, filed on Oct. 4, 2019.

(51) Int. Cl. C05F 17/20; C05F 17/40; C05F 1/00

(52) U.S. Cl. CPC C05F 17/20; C05F 17/40; C05F 1/00

(57) ABSTRACT

A method for producing an organic nutrient slurry from organic material containing at least one of animal material and plant material is provided. The method includes introducing the organic material into a pressurized reactor and subjecting the organic material to agitation and saturated steam at a temperature and pressure within the pressurized reactor for a duration of time sufficient to thermally hydrolyze and denature the organic material into a denatured slurry having mineral particle sizes of less than 200 microns; conveying the denatured slurry and at least one microbial inoculant to an aerobic reactor to form a mixture therein; and introducing oxygen to the aerobic reactor to stimulate aerobic digestion of the mixture, while maintaining the mixture at a predetermined temperature range and predetermined pH range sufficient to support the aerobic digestion, in order to produce an organic nutrient slurry for plants.

### CROSS-REFERENCE TO RELATED APPLICATIONS

This application claims priority from U.S. Provisional Patent Application No. 62/910,947, filed Oct. 4, 2019, the disclosure of which is herein incorporated by reference in its entirety.

### BACKGROUND OF THE INVENTION

Natural decomposition of organic material, such as carcasses, animal by-products (ABP), food waste and other certain specified risk material (SRM), to assure that they are eliminated from human and animal food chains, is a lengthy and complex process. Therefore, disposing or recycling of such organic material, particularly organic waste material, has long been a problem.

In soil science, the decomposition process of organic material is referred to as mineralization. Mineralization is the decomposition (i.e., oxidation) of the chemical compounds in organic matter, as a result of which the nutrients in those compounds are released in soluble inorganic forms that may be available to plants.

In animal science, the decomposition process of animal material involves the breakdown of soft tissue as the animal material passes through the sequential stages of decomposition, as a result of which nutrients are released. A nutrient cycle (or ecological recycling) is the movement and exchange of organic and inorganic matter back into the production of matter. Energy flow is a unidirectional and noncyclic pathway, whereas the movement of mineral nutrients is cyclic. Mineral cycles include the carbon cycle, sulfur cycle, nitrogen cycle, water cycle, phosphorus cycle and oxygen cycle, among others, that continually recycle along with other mineral nutrients into productive ecological nutrition. All forms of recycling have feedback loops that use energy in the process of putting material resources back into use. Recycling in ecology is regulated to a large extent during the process of decomposition. Ecosystems employ biodiversity in the food webs that recycle natural materials, such as mineral nutrients, which includes water. Recycling in natural systems is one of the many ecosystem services that sustain and contribute to the well-being of human societies.

Decomposition of animal material often involves proteolysis, the process that breaks down proteins. Proteolysis is regulated by parameters such as moisture content, temperature, and bacteria. Proteolysis does not occur at a uniform rate amongst all types of proteins, and thus some proteins are degraded during the early stages of decomposition, while others are degraded during later stages of decomposition. In terms of animal material, such as carcasses and animal by-product, only the soft tissue proteins are broken down during the early stages of decomposition, while more resistant tissue proteins are degraded by the effects of putrefaction during the later stages of decomposition. Examples of such resistant tissue proteins include, reticulin, muscle protein, collagen and a hard tissue protein (which survives even longer than the aforementioned tissue proteins) and keratin. Keratin, in particular, is a protein which is found in skin, hair, and nails, and it is most resistant to the enzymes involved in proteolysis. Keratin must be broken down by special keratinolytic microorganisms.

Proteolysis breaks down the proteins found in animal material into proteoses, peptones, polypeptides and amino acids. The result of the decomposition process are nutrients that may be used for plant growth. For example, nitrogen is a component of amino acids (produced as a result of decomposition) and is released upon deamination, typically in the form of ammonia which is used by plants or microbes in the surrounding environment, and converted to nitrate. Another nutrient source which results from the decomposition process is phosphorus, which can be released from various components of the body, including proteins (especially those making up nucleic acids), sugar phosphate, and phospholipids. The route phosphorus takes once it is released is complex and relies on the pH of the surrounding environment. In most soil environments, phosphorus exists as insoluble inorganic complexes, associated with iron, calcium, magnesium, and aluminum. Soil microorganisms can then transform insoluble organic complexes into soluble ones. In addition, calcium and micronutrients all become available for plant growth.

Therefore, animal material, and particularly animal waste products, are a very viable and prolific source material for producing plant nutrients. However, as mentioned above, natural decomposition of animal and plant material is a lengthy process. For example, an animal carcass may take about one year for skeletal decomposition and many years for complete decomposition, depending on the environment. In turn, the natural nutrient cycle starting with animal and/or plant material as the source material is a lengthy process.

Therefore, there is a need for a technology that accelerates the nutrient cycle for the generation of plant nutrients from organic animal and plant material as the source material. The ideal solution would be the conversion and refinement of meat, bone, fat and fiber materials derived from waste or condemned animal and plant sources to nutrient products for plants, especially for hydroponic plant growth. The present invention provides such a solution.

### BRIEF SUMMARY OF THE INVENTION

The present invention effectively addresses the problem of treatment and environmentally safe disposal of organic material through a bio-refining process which transforms the organic material, particularly infectious material such as waste household foods, waste or condemned meat and bone residuals from food processing industries, dead and diseased animal carcasses from all sources, dewatered sewage sludge, SRM, ABP, and other solid and liquid organic material, into denatured, value-added products, particularly liquefied plant nutrients.

The present invention relates to a method for producing an organic nutrient slurry from organic material comprising at least one of animal material and plant material. The method comprises introducing the organic material into a pressurized reactor and subjecting the organic material to agitation and saturated steam at a temperature and pressure within the pressurized reactor for a duration of time sufficient to thermally hydrolyze and denature the organic material into a denatured slurry, the denatured slurry having mineral particle sizes of less than 200 microns; conveying the denatured slurry and at least one microbial inoculant to an aerobic reactor, the denatured slurry and at least one microbial inoculant forming a mixture in the aerobic reactor; and introducing oxygen to the aerobic reactor to stimulate aerobic digestion of the mixture, while maintaining the mixture at a predetermined temperature range and predetermined pH range sufficient to support the aerobic digestion, in order to produce an organic nutrient slurry for plants.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a block diagram of the process for forming an organic nutrient slurry in accordance with an embodiment of the present invention; and

FIG. 2 is a schematic of the process for forming an organic nutrient slurry in accordance with an embodiment of the present invention.

### DETAILED DESCRIPTION OF THE INVENTION

Certain terminology is used in the following description for convenience only and is not limiting. Unless specifically set forth herein, the terms “a,” “an” and “the” are not limited to one element, but instead should be read as meaning “at least one.” The terminology includes the words noted above, derivatives thereof and words of similar import. As used herein, the singular includes the plural and the plural includes the singular, unless otherwise specifically stated or clear from the context.

In general, this invention relates to the accelerated production of mineralized organic nutrient products suitable for plant growth in hydroponic, foliar and soil applications, from a source material comprised of organic animal and plant material. The present invention is designed to process organic material, such as organic waste, residual and/or condemned products from plant and animal sources, providing an alternative to current landfilling, incineration or large industrial compost plants, and to convert currently restricted infectious and obnoxious organic materials into valuable and safe liquefied organic plant nutrients.

The process according to the present invention accelerates the nutrient cycle of animal and/or plant organic material to a duration of two to three weeks, as compared with one year as is typical for the natural cycle. The process generally involves two main stages of processing, including thermal hydrolysis followed by aerobic digestion. Each stage is described in detail herein. Briefly, thermal hydrolysis is a chemical process in which a molecule is split into two parts by the addition of a molecule of water. In the context of animal material, for example, thermal hydrolysis results in water molecules being forced between the chemical bonds holding large tissue molecules such as fats, DNA and proteins together, and uses a combination of high temperature and high pressure to break the tissue down to their original small molecular building blocks. When complex insoluble compounds undergo hydrolysis, the large polymeric substances consisting of many small molecules joined together by unique chemical bonds are split apart. Once the chemical bonds are broken, the small molecules become soluble and quickly go into solution, and complex carbohydrates become simple sugars, complex lipids (fats) become fatty acids and glycerol and complex proteins become amino acids. Sufficient water content is the only additive to the process. The resultant slurry, namely the hydrolysate, is a sterile and denatured product which is then fed into an aerobic digester. During the aerobic digestion process, the organic compounds of the sterile hydrolysate slurry are broken down, by which the nutrients in those compounds are released in soluble inorganic forms that may be available to plants and CO₂ in the presence of oxygen and forms a liquefied nutrient product. This process is known as mineralization.

The resulting liquefied nutrient product provides an alternative fertilizer to the chemical products that are widely used in hydroponic applications, especially in multi-level vegetable factories and medical marijuana growth systems. It is also notable that a liquid organic fertilizer is essential for hydroponic facilities, particularly those situated in jurisdictions which offer organic certification (i.e., organic certified plants), and ecologically managed greenhouses and farms.

Examples of the organic material that may be used as source material in the process of the present invention include one or more of the following: specified risk material, animal by-product, human, animal and plant waste, residual or condemned materials, such as food wastes and food processing wastes from household and food services businesses; diseased plants, such as those affected by fungal diseases; residual meat and bones from meat and fish packers; livestock, poultry and pet carcasses from farm, feedlots, slaughter houses, and veterinarian clinics; classified or condemned animal carcasses, body parts, organs and tissues which may be specified by national, regional or community disease and control programs for destruction; animal offal; municipal solid waste containing such waste; sewage sludge from wastewater treatment plants; residual plant materials, such as grass clippings, leaves, shrub trimmings, flowers, and any other plant materials including cellulosic fibers; as well as any combination or mixture of any of these materials.

As used herein, the term “infectious organic waste material” means organic waste material which is actually or potentially infectious, in that it actually or potentially includes any type of pathogenic agent that is capable of causing illness or disease in a human or an animal, including but not limited to the types set forth in the immediately preceding paragraph. Thus, the term includes organic waste materials that are expected or suspected to be infectious by virtue of some samples of other batches or general types of such materials having been found to contain pathogens. It is not necessary that the material being treated actually be tested in advance to determine whether or not it is actually infectious, and therefore, the infectious organic waste material may not be actually infectious. Typically, such organic waste material is by regulation or tradition inedible.

As used herein, the term “denature” and its grammatical equivalents, means both to sterilize and to inactivate pathogenic agents such that they are no longer harmful to humans or animals. This term is chosen for use herein as applying to pathogens commonly found in plants, such as fungi, oomycetes, bacteria, viruses, viroids, virus-like organisms, phytoplasmas, protozoa, nematodes, parasitic plants or other microorganisms capable of metabolism and reproduction on their own. This term is chosen for use herein as also applying to common cannabinoids found in plants of the cannabis species including, for example, THC (tetrahydrocannabinol), THCA (tetrahydrocannabinolic acid), CBD (cannabidiol), CBDA (cannabidiolic acid), CBN (cannabinol), CBG (cannabigerol), CBC (cannabichromene), CBL (cannabicyclol), CBV (cannabivarin), THCV (tetrahydrocannabivarin), CBDV (cannabidivarin), CBCV (cannabichromevarin), CBGV (cannabigerovarin), CBGM (cannabigerol monomethyl ether), CBE (cannabielsoin), CBT (cannabicitran).

The term “denature” and its grammatical equivalents are also chosen for use herein as applying to antibiotics that may be found in animal material, such as Amoxicillin, Lacalocid, Sulfadimethoxine, Ampicillin, Monensin, Sulfaethoxypyridazine, Bacitracin, Neomycin, Sulfamethazine, Ceftiofur, Oxytetracycline Sulfamethoxine, Chlortetracycline, Tetracycline, Dihydrostreptomycin, Penicillin, Tilmicosin, Erythromycin, Streptomycin, Tylosin, Furomazine, Sulfabromomethazine, Gentamycin and Sulfachloropyridazine; and to hormones that may be found in animal waste, such as Estradiol, rBST, Zeranol, Melengestrol Acetate, Testosterone, Progesterone and Trenbolone Acetate.

The term “denature” and its grammatical equivalents are also chosen for use herein as applying to viruses which may be viewed as either extremely simple microorganisms or as extremely complex molecules that typically contain a protein coat surrounding an RNA or DNA core of genetic material but no semipermeable membrane, that are capable of growth and multiplication only in living cells; and also TSEs or prions, such as BSE, CWD and scrapie, which are proteins, rather than microorganisms, but nonetheless interact with human and animal biochemicals to form a template or pattern which causes illness or disease.

Thus, the term “denature” is used herein as a term which encompasses rendering any of the aforementioned harmful pathogenic agents not harmful according to the method of the present invention, regardless of whether the pathogenic agent is rendered not harmful by sterilization, inactivation, thermal hydrolysis or any other technique within the method of the present invention.

As used herein, the term “hydrolyzed, sterile product” or “sterile hydrolysate” includes any beneficial product, such as amino acids, fatty acids, minerals and fibrous or non-fibrous organic nutrient substances, which result from the denaturing process described herein.

As used herein, “animal by-product” (ABP) means any animal-derived material not intended for human consumption, whether or not it is infected with any infectious agent, that is or may be regulated by any government or government agency or government organization, such as European Union Regulation EC 1774/2002 of the European Parliament and the European Council that was adopted Oct. 3, 2002, the Statutory Instrument 2005 No. 2347 Animal By-Products Regulations 2005 in England, and others. Such ABPs include, for example, parts of a slaughtered animal that are not directly consumed by humans, including dead on-farm animals, culled spent hens and catering waste (waste food originating from restaurants, catering facilities and kitchens) that contains or has been in contact with meat products, whether cooked or uncooked, some of which may be used in animal proteins like meat-meal, bone-meal, fats, gelatin, collagen, pet food and other technical products, such as glue, leathers, soaps, fertilizers, etc. Animal carcasses, body parts, organs or tissues which may be treated according to the present invention include those of typical livestock including cattle, sheep, goats, hogs, pigs, horses, and poultry including chickens, geese, and ducks, domestic pet animals, such as dogs and cats, zoo animals, and virtually any other animal from any sources whose carcass, body parts, organs or tissues must be disposed.

As used herein, the term “specified risk material” (SRM) means any material that is the type that is, or may be, or is susceptible of being, infected with any infectious agent, such as BSE and scrapie, and that is or may be regulated by any government or government agency or government organization, such as Interim Final Rule of the U.S. Department of Agriculture, Food Safety Inspection Service, published in the Federal Register of Jan. 12, 2004, at page 1862 et seq., the European Union Community TSE Regulation 9999/2001, and the Canadian Food Inspection Agency regulations effective Aug. 23, 2003. Such SRMs include, for example, for cattle: tonsils, intestines, skull excluding the mandible but including the brain and eyes and spinal cord, vertebral column with certain exceptions, and the dorsal root ganglia; and for sheep and goats, the spleen and ileum and skull, including the brains and eyes.

The source material to be treated effectively according to the present invention is preferably organic material. The organic material may be introduced into a suitable reactor or vessel in the form in which its components are received from a source, such as a slaughter house, processing plant or other source. Typically, the organic material is received for treatment in the form of whole or somewhat broken skulls, vertebral columns, large and small bones, defatted meat and bone materials, and other components, typically, but not necessarily with flesh and fat attached, and without having been comminuted to smaller particles.

The source material preferably comprises plant and/or animal products, including spent hens, cracks (meat and bone meal), SRM and ABP. More preferably, APB are used as at least a part of the source material, since ABP provide a rich source of nitrogen, phosphorus and calcium and a complete natural source of micronutrients essential for plant growth.

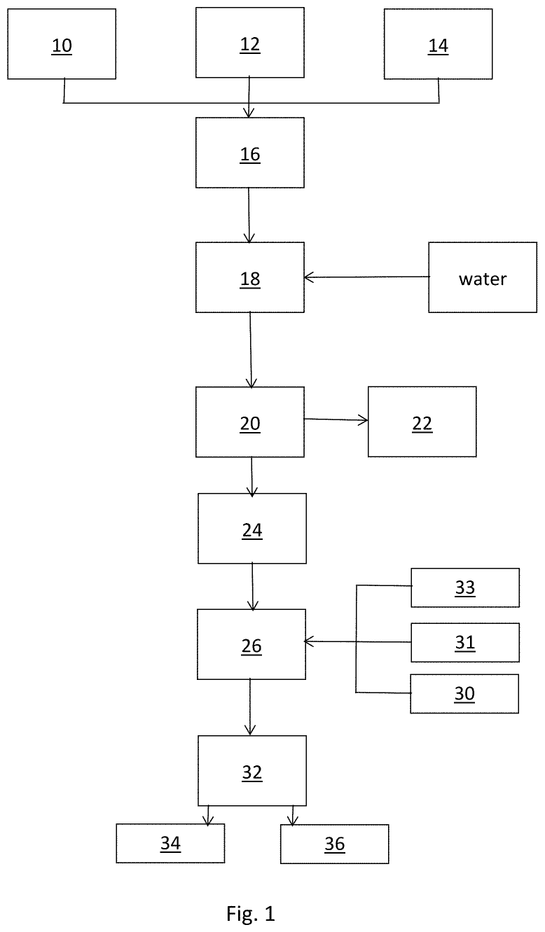

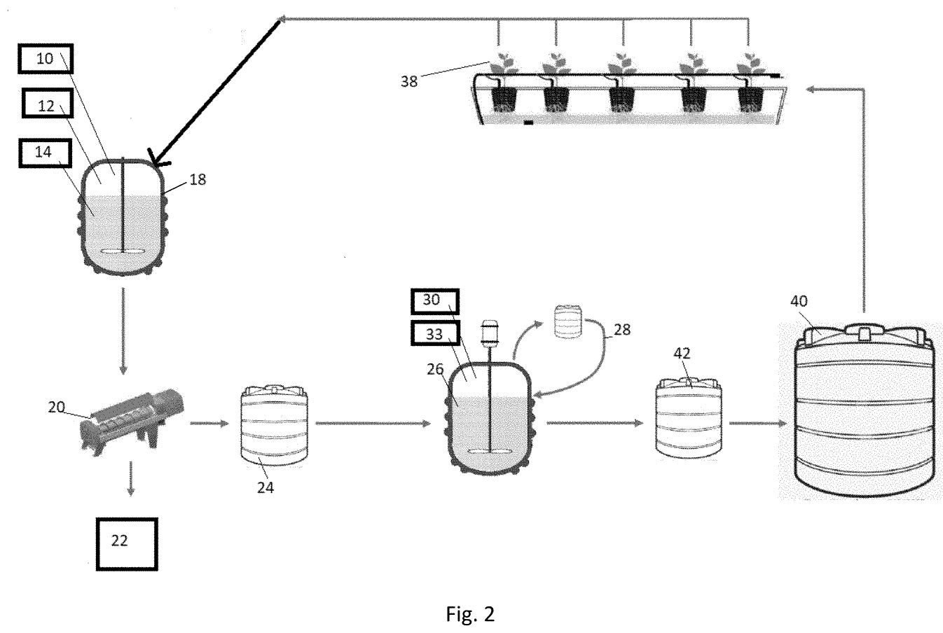

Referring to FIGS. 1-2, in one embodiment, the source material is comprised of organic material, particularly plant material 10, SRM 12 and ABP 14, which may be mixed together prior to further processing or which may be separately introduced for further processing. The plant material 10 may be, for example, recycled plant waste including root and growth medium.

Optionally, as a first step, the organic material, which may contain any or all of the previously mentioned materials, is comminuted in a vessel 16, such as by grinding or shredding into particles of a desired size to form a reaction mixture, more specifically to facilitate efficient and uniform heat and steam penetration into the particles. The comminuting may be done using any suitable equipment, such as pre-breaker grinders, crushers, hammer mills or shear shredders. Comminuting should be done in an enclosed environment to avoid aerosol pathogen emissions into the outside environment. The preferred comminuting is done until the material has an average particle size sufficient to facilitate and enhance heat and steam penetration such that the organic material is substantially uniformly denatured. Comminuting the material also makes handling it more efficient, since comminuted material may be conveyed more easily into and out of the reactor, such as by pumping, as the organic material usually includes sufficient liquid, typically water, to be pumpable. Comminution also increases the packing density within the thermal hydrolysis reactor 18, and allows for faster processing due to the smaller particles and increased surface area subjected to thermal hydrolysis, compared to larger particles or pieces of material being treated. The specific size of the particles of the comminuted material depends on the density, type and nature of material being comminuted, but generally, the material is comminuted sufficiently if the size is reduced to a maximum largest dimension of up to about 50 mm, and more preferably about 20 mm to about 50 mm in the maximum largest dimension. If the particle sizes of the source material already fall within such dimensions, there may be no need to comminute the source material.

Additives may be added to the source material, either before or after comminution (i.e., to the resulting reaction mixture). Examples of such additives include, but are not limited to, extraneous leaves which provide a good source of humic acid.

Next, the source material, either in its original form or after having been comminuted, is subjected to thermal hydrolysis in a reactor 18. Preferably, a carbon/nitrogen ratio (C:N) of the source material is in the range of 15:1 to 50:1. More particularly, the source material is transferred, such as by pumping, into a reactor or vessel 18 designed to allow sufficient interaction of the source material with heated and pressurized saturated steam, such as a batch or continuous process hyperbaric mixing reactor with at least one shaft having radially offset mixing paddles extending from the shaft, or a rotating and or oscillating vessel with internal offset fixed flanges. Other suitable batch or continuous process reactors or mixing vessels could be used. The source material is heated in the reactor with saturated steam at an elevated temperature and super-atmospheric pressure for a time sufficient to thermally hydrolyze the mixture, in the absence of additional extraneous acid or alkaline chemicals, in the absence of additional extraneous oxidizing agents and in the absence of additional extraneous fibrous material, such as additional absorbent or adsorbent fibrous material.

Suitable preferred conditions for denaturing the source material include heating to a temperature of about 120° C. to about 200° C., more preferably about 180° C., and pressurizing to a pressure of about 5 bar (about 72.5 pounds per square inch (psi)) to about 15 bar (about 217.8 psi), more preferably about 10 bar (about 145 psi) to about 13 bar (about 188.5 psi), for a duration of time of about 20 minutes to about 160 minutes, more preferably about 20 minutes to about 120 minutes, and most preferably for about 40 minutes. Such conditions break down tissue to their original small molecular building blocks, resulting in a dramatic reduction in viscosity. Such conditions also ensure the destruction of infectious agents, including TSEs, spore forming bacteria and prions, by denaturing the tertiary structures of the prions or protein and destroying the infectious functional nature of the pathogenic agents, and also increase biodegradability. Such conditions also effectively denature other materials from the reaction mixture, such as cannabinoids, pathogens, antibiotics and hormones.

More particularly, the high temperature saturated steam and high pressure conditions break down the molecular bonds of the protein, carbohydrates, fats, DNA and mineral compounds, hydrolyzing and denaturing the original molecular structures to primary forms of beneficial products, such as peptides, amino acids, fatty acids, sugars (glycerin), lignans, cellulose and minerals, into a resulting aqueous slurry that is largely organic, incorporating water naturally present in the organic material, as well as the injected steam. The thermal hydrolysis process also results in the reduction of particle sizes of the organic compounds, which increases the surface area for enhanced microbial digestion. For example, the resulting mineral particle sizes in the sterile hydrolysate slurry typically have diameters of less than 200 microns, and more preferably with volume means ranging from 60-120 microns.

It will be understood by those skilled in the art that the specific conditions used for thermally hydrolyzing the source material and the resulting particle sizes of the hydrolysate slurry depend on the type and composition of the source material. Therefore, when suitable, the thermal hydrolysis conditions may vary from those discussed above, as long as the conditions are suitable for denaturing the source material. Also, the particle sizes in the sterile hydrolysate slurry may vary depending on the type and composition of the source material.

The above-described treatment of the organic material denatures the material, rendering it non-infectious and sterile. Upon denaturation, the organic material that has been converted to the denatured slurry has a target infectivity reduction of ID₅₀ of a minimum of 4 logs. Infectivity is a measure of the ability of a disease agent to establish itself in the host. Attempts to quantify infectivity typically involve the use of ID₅₀, which is the individual dose or numbers of the agent required to infect 50% of a specified population of susceptible subjects under controlled environmental conditions The factor “4 logs” means that the amount of infectious material is reduced by four orders of magnitude equal to 1×10⁴, or 10,000.

Following denaturation of the source material, the thermal hydrolysis reactor 18 is preferably depressurized.

In one embodiment, the hydrolyzed, sterile, denatured slurry (also referred to herein as “sterile hydrolysate slurry” or more simply as “denatured slurry”) is then directly employed in an aerobic digestion process, as described in further detail herein.

In another embodiment, prior to aerobic digestion, the denatured slurry is first subjected to a separation process 20, such as dewatering (e.g., using a screw press), fractionation, centrifugation and the like, based on the molecular weight, density and particle size of the various components of the sterile hydrolysate slurry. For example, the separator 20 may be a high speed centrifuge to achieve classification of various products or a screw press (see FIG. 2) to separate the sterile hydrolysate slurry into solid and liquid fractions, and more particularly to cause solids, such as fibrous lignans, cellulose and minerals, fibrous lignins and fibrous coir, to separate from the liquid fraction, resulting in a semi-dry or semi-moist fibrous material. The residual solids therefore comprise fibrous material that is mostly made of “paunch manure” from the animals' stomachs, other grain and feed residues in the small and large intestines of the animals and any commingled or other vegetable or fruit fibers, and/or fibrous plant lignins and coir which did not break down during the thermal hydrolysis stage.

Additional liquid-liquid separations or dehydration of the solid and liquid fractions, for example, to concentrate amino acids, may be further undertaken to develop specific industrial, commercial, or agricultural products. For example, dehydration results in stable, transportable nutrient products.

Preferably, after separation, the residual solids fraction 22 can be used for other products, such as amino acids and minerals for animal feed, fertilizers, bone meal, nutriceutical compositions, and materials for soil reclamation, remediation and conditioning (e.g., as a material for soil amendments), as well as many other uses.

The denatured slurry 24, either directly from the thermal hydrolysis reactor 18 or from the separator 20, is then transferred to an aerobic reactor 26. At least one microbial inoculant 30 is also introduced into the aerobic reactor 26 and forms a mixture comprised of the denatured slurry 24 and the microbial inocula 30. It will be understood that any point after production of the denatured slurry 24 and prior art introduction into the aerobic reactor 26, the denatured slurry 24 may be housed in a storage vessel pending demand for the slurry 24. Again, as discussed above, in the denatured slurry 24, proteins have been broken down into peptides and amino acids, fats have been broken down into fatty acids and glycerin, and the particle sizes of organic compounds (such as bone fragment particles) have been reduced. At this stage, the denatured slurry 24 preferably has a moisture content of 75% to 90%. It will be understood by those skilled in the art that the moisture content of the denatured slurry 24 will depend and may vary from the preferred range, depending on the type and composition of the source material.

In the aerobic reactor 26, the denatured slurry 24, and more particularly, the mixture comprised of the denatured slurry 24 and the microbial inocula is subjected to aerobic digestion or fermentation. For the sake of simplicity, the aerobic process is referred to herein as aerobic digestion. The aerobic digestion is a batch process or semi-continuous process in which the denatured slurry 24 is mixed or seeded with the microbial inoculant or inocula 30 while oxygen 33 is percolated throughout the mixture of the denatured slurry 24 and the microbial inocula 30 to stimulate aerobic digestion. The microbial inocula 30 are preferably derived from various sources such as compost or soil, selected designer microbes, or from residual cultures held over from the preceding reactor batch as reflected by stream 28 in FIG. 2. Preferably, the at least one microbial inoculant is selected from the group consisting of bacteria, fungi and actinomycetes. Also preferably, at least a portion of the microbial inocula 30 is a residual culture held over from the preceding reactor batch.

In one embodiment, additives, such as mined minerals, are added to the aerobic reactor 26. The additives are preferably selected depending on the type and composition of the source material and the desired composition of the plant nutrient to be produced. More particularly, the additives are selected to compensate for nutrient deficiencies of the source material. For example, the source material often lacks sufficient potassium to produce suitable liquefied plant nutrients, and thus mined minerals such as mined potash and mined dolomite, are added to the mixture in the aerobic reactor 26, to ensure that the resulting liquefied plant nutrients comprise the nutrients essential for promoting plant growth. The additives to be used are preferably organic, more preferably certified organic ingredients.

The mixture of the denatured slurry 24 and microbial inocula 30 (and optional additives) is preferably subjected to agitation during the aerobic digestion process. Preferably, the mixture of the denatured slurry 24 and microbial inocula 30 is agitated for the duration of the mesophilic and/or thermophilic digestion phases, which are accelerated due to the enhanced properties of the denatured organic material in comparison to processing raw material which would typically require a longer duration cycle for complete mineralization. The rate and duration of agitation are preferably sufficient to entrain oxygen in the mixture and to ensure that there are no anaerobic pockets in the aerobic digestion reactor 26.

The aerobic digestion process according to the claimed invention is carried out for a duration sufficient to achieve oxidation, mineralization or ammonification, and more particularly to achieve the breakdown of the organic material of the mixture of the denatured slurry 24 and microbial inocula 30 into minerals and carbon dioxide, in the presence of oxygen, to form a bioreacted nutrient material. Typically, the aerobic digestion process is carried out for approximately 7 to 30 days, preferably 10-20 days, and more preferably 10-15 days. It will be understood that the duration of the aerobic digestion process may vary depending on the type and composition of the source material.

In one embodiment, a portion of the bioreacted nutrient material may be withdrawn from the aerobic reactor 26 and subsequently used to inoculate the next batch of the denatured slurry 24 (see stream 28 in FIG. 2).

During the aerobic digestion process, the pH of the mixture of the denatured slurry 24 and microbial inocula 30 is preferably monitored and controlled, for example using a sensor and controller assembly (not shown), to maintain optimal pH levels within the aerobic reactor 26. Optimal pH levels are those which support the aerobic digestion, prevent ionization of the ammonia and avoid the formation of a precipitate, namely between 3.5 and 7, more preferably between 5.8 and 6.8, and most preferably approximately 6.3. For example, if the pH of the mixture contained within the aerobic reactor 26 falls below or above the desired pH level (e.g., as detected by one or more pH sensors), the system may then be triggered to introduce one or more base or acid chemical reagents 31, such as anti-foaming agents, to the aerobic reactor 26 to adjust the pH of the mixture to the desired pH levels. Preferably, the chemical reagents 31 used to adjust the pH are suitable for organic standards and/or production.

Also, during the aerobic digestion process, the temperature of the mixture contained within the aerobic reactor 26 is monitored, for example using a temperature sensor, and can be controlled by increasing or decreasing the dissolved oxygen content by regulating the flow oxygen being introduced into the reactor 26.

The bioreacted nutrient material 42 produced in the aerobic reactor 26 is an organic nutrient slurry that has greatly reduced odorous properties and in which the hydrolysate nutrient has been biologically broken down into plant available form. Nitrogen, a key nutrient source for plants, has been preserved in the organic nutrient slurry 42 as ammonia (NH₄). More particularly, the organic nutrient slurry 24 is rich in or enhanced with at least one of ammonia, phosphorus, potassium, calcium and micronutrient molecules suitable for promoting plant growth.

The organic nutrient slurry 42 produced in the aerobic reactor 26 may then be used as is as a liquified organic plant nutrient. For example, as shown in FIG. 2, the organic nutrient slurry 42 may be conveyed from the aerobic reactor 26, then optionally stored in a storage vessel when desired, and ultimately injected or otherwise introduced into a hydroponic water system 38, or for foliar or fertigation soil applications.

In another embodiment, depending on the material composition of the organic nutrient slurry 24, the slurry 24 may be subjected to a separation process 32 (e.g., fractionation or centrifugation), for example based on weight, density and particle sizes, to generate separate liquid and solid nutrient fractions 34, 36, both of which serve as plant nutrient sources for, e.g., hydroponic growth systems, drip fertigation applications and/or foliar spray applications. The liquid fraction 34 comprises, preferably predominantly, nitrogen rich material, while the solid fraction 36 comprises, preferably predominantly, calcium and phosphorus rich material. Both the liquid and solid fractions 34, 36 have particle sizes of 200 microns or less.

In another embodiment, as shown in FIG. 2, the organic nutrient slurry 42 may be enhanced with at least one nitrification inoculant, for example a nitrate forming bacteria, in a further reactor or vessel 40, depending on the end application of the organic nutrient slurry 42. The nitrogen enhanced organic nutrient slurry may then be introduced into a hydroponic water system 38, or for foliar or fertigation soil applications.

More particularly, when used in a hydroponic water system 38, the organic nutrient slurry 42 is circulated through the system, preferably through a growth medium of coir and gel bone. Drip effluent or overflow from the hydroponic water system 38 may then be recirculated through the system 38 or may be removed and recycled as plant waste, along with the growth medium, to form part of the source material for the next batch.

The nutrient cycle according to the process of the present invention is therefore accelerated to a duration of, for example, 2 to 3 weeks, as compared with approximately 1 year as required for a natural nutrient cycle for plant and animal material, depending on the solids content of the original sterile slurry.

The invention will now be described in more detail with reference to the following specific, non-limiting example.

### Example—Sample Hydrolysis and Aerobic Digestion of Infectious Animal By-Product and Organic Material

A source material is composed of a volume of spent hens (e.g., old laying hens which are a by-product of egg and hatching egg production). The spent hens are comminuted to a particle size of approximately 50 mm, and the comminuted material is then thermally hydrolyzed in a high pressure reactor vessel which is steam heated in the vessel to a temperature of 180° C. and a pressure of 10 to 13 bar, preferably 12.4 bar. The material is subjected to these conditions for a period of 40 minutes while being agitated by internal shaft and paddles rotating at 30 rpm within the reactor vessel.

Following the thermal hydrolysis cycle, the vessel is depressurized and the steam is vented to a condenser system. At ambient pressure, the sterile hydrolysate slurry is evacuated from a bottom port of the reactor vessel and conveyed to an aerobic digestion reactor. A microbial inoculant from the previous batch remains in the aerobic digestion reactor and is mixed with the sterile hydrolysate slurry to form a mixture, while a 80% to 95% pure oxygen content is percolated throughout the mixture in the aerobic digestion reactor, and while the mixture is constantly agitated to ensure that there are no anaerobic pockets in the aerobic digestion reactor. In the aerobic digestion reactor, rapid microbial growth occurs and is reflected by a fluctuation in the mixture temperature. More particularly, the mixture undergoes multiple temperature fluctuations based on the metabolic activity of the bacteria contained therein. The temperature of the mixture is monitored by a temperature sensor. The pH of the slurry is also monitored by a pH sensor and maintained at a pH of 6.3. Completion of the mineralization is observed by a decrease in the temperature (and thus microbial activity) of the slurry, particularly as the temperature decreases back to ambient temperatures. The complete mineralization takes approximately three weeks. The resulting nutrient slurry is rich in nitrogen from the protein and feathers of the fowl, and also rich in phosphorus and calcium from the bone, and contains essential micronutrients essential for plant health.

The present invention therefore converts animal and plant materials into liquified organic nutrients by a multistage process involving thermal hydrolysis of the animal and plant materials to produce a sterile (denatured) hydrolysate and aerobic digestion of the sterile hydrolysate.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/We claim:

1. A method for producing an organic nutrient slurry from organic material comprising at least one of animal material and plant material, the method comprising
introducing the organic material into a pressurized reactor and subjecting the organic material to agitation and saturated steam at a temperature and pressure within the pressurized reactor for a duration of time sufficient to thermally hydrolyze and denature the organic material into a denatured slurry, the denatured slurry having mineral particle sizes of less than 200 microns;
conveying the denatured slurry and at least one microbial inoculant to an aerobic reactor, the denatured slurry and at least one microbial inoculant forming a mixture in the aerobic reactor; and
introducing oxygen to the aerobic reactor to stimulate aerobic digestion of the mixture, while maintaining the mixture at a predetermined temperature range and predetermined pH range sufficient to support the aerobic digestion, in order to produce an organic nutrient slurry for plants.

2. The method according to claim 1, wherein the aerobic digestion comprises one of oxidation, ammonification and mineralization of the reaction mixture.

3. The method according to claim 1, wherein the organic nutrient slurry is enhanced with at least one of ammonia, phosphorus, potassium, calcium and micronutrient molecules suitable for promoting plant growth.

4. The method according to claim 1, further comprising separating the organic nutrient slurry based on weight, density and particle sizes to form a liquid nutrient fraction and a solid nutrient fraction.

5. The method according to claim 4, wherein the liquid nutrient fraction predominantly comprises nitrogen rich material and wherein the solid nutrient fraction predominantly comprises calcium and phosphorus rich material.

6. The method according to claim 1 wherein a carbon/nitrogen ratio (C:N) of the organic material is in the range of 15:1 to 50:1.

7. The method according to claim 1, wherein the saturated steam is at a temperature of about 120° C. to about 200° C. and a pressure of about 5 bar to about 15 bar.

8. The method according to claim 7, wherein the steam is at a temperature of about 180° C.

9. The method according to claim 1, wherein the reaction mixture is subjected to the saturated steam for a time of about 20 minutes to about 160 minutes.

10. The method according to claim 9, wherein the reaction mixture is subjected to the saturated steam for a time of about 40 minutes.

11. The method according to claim 1, wherein the at least one microbial inoculant is selected from the group consisting of bacteria, fungi and actinomycetes.

12. The method according to claim 1, wherein the predetermined pH of the reaction mixture is maintained at a level between 3.5 and 7.

13. The method according to claim 1, wherein the animal material comprises at least one of animal fat, animal flesh, animal bone, animal blood, milk, eggs, shells, animal skins, animal feathers.

14. The method according claim 1, further comprising enhancing the organic nutrient slurry with at least one nitrification inoculant.

15. The method according to claim 1, wherein thermal hydrolysis of the organic material denatures all cannabinoids in the plant material.

16. The method according to claim 1, wherein thermal hydrolysis of the organic material denatures all pathogens in the plant material.

17. The method according to claim 1, wherein thermal hydrolysis of the organic material denatures all antibiotics in the animal material.

18. The method according to claim 1, wherein thermal hydrolysis of the organic material denatures all hormones in the animal material.

19. The method according to claim 1, wherein mined minerals are added to the aerobic reactor together with the denatured slurry and the at least one microbial inoculant.
